(19) United States
(12) Patent Application Publication
(10) Pub. No.: US 2025/0083656 A1
(43) Pub. Date: Mar. 13, 2025

(54) BRAKING CONTROL DEVICE

(71) Applicant: Hitachi Astemo, Ltd., Hitachinaka-shi, Ibaraki (JP)

(72) Inventor: Yukiya ISHII, Tokyo (JP)

(73) Assignee: Hitachi Astemo, Ltd., HItachinaka-shi, Ibaraki (JP)

(21) Appl. No.: 18/727,303

(22) PCT Filed: Aug. 24, 2022
(86) PCT No.: PCT/JP2022/031916

§ 371 Date: Jul. 8, 2024

(30) Foreign Application Priority Data
Jan. 17, 2022 (JP) 2022-005235

(51) Int. Cl. B60W 10/18; B60W 40/10

(52) U.S. Cl. CPC B60W 10/18; B60W 40/10; B60W 2520/10; B60W 2556/50

(57) ABSTRACT

Provided is a braking control device configured to apply auxiliary braking force only as needed, for example, when a travel path of a vehicle includes a curve such as a blind corner, and configured to apply the auxiliary braking force without causing a driver of the vehicle to feel uneasy about operation. The braking control device calculates target braking force based on reference braking force and input braking force information (a driver-input braking force converted value), calculates, based on the target braking force, the auxiliary braking force for reducing uneasiness (performing a process to reduce uneasiness) felt by the driver about the braking operation, and then calculates final target braking force by using the auxiliary braking force (by adding the auxiliary braking force to the driver-input braking force converted value).

### TECHNICAL FIELD

The present invention relates to a braking control device for controlling braking force when a vehicle travels. The braking control device applies, during braking operation by a driver of the vehicle, auxiliary braking force without causing the driver to feel uneasy about the operation, even when the driver selects wrong approaching speed to a blind corner or others.

### BACKGROUND ART

Various control techniques related to the above have been provided, such as disclosed in PTL 1. The technique disclosed in PTL 1 provides a vehicle control device configured to control deceleration of a vehicle and generate an alarm before reaching a curve in a suitable manner for a driver of the vehicle.

Another known technique assists the deceleration based on curve information from a navigation system installed in the vehicle.

### CITATION LIST

### Patent Literature

PTL 1: JP H11-222055 A

### SUMMARY OF INVENTION

### Technical Problem

With the techniques described above, in scenes other than a scene where the driver has an intention to decelerate the vehicle (more specifically, even when the driver does not step in a brake pedal), auxiliary deceleration may be provided, thereby causing the driver to feel uneasy about operation.

Here, the auxiliary deceleration provided to the vehicle is assumed to be relatively gentle to an extent corresponding to an engine brake, in other words, approximately 0.05 to 0.1 [G] in G conversion. Thus, when relatively greater deceleration (specifically, deceleration above 0.1 [G]), such as typical braking force generated by a friction brake, is provided, a sudden change in G force in response to the deceleration may increase discomfort felt by the driver and cause the driver to feel uneasy.

In view of the respects described above, an object of the present invention is to provide a braking control device configured to apply auxiliary braking force only as needed, for example, when a travel path includes curves such as a blind corner, and configured to apply the auxiliary braking force without causing the driver to feel uneasy about the operation.

### Solution to Problem

In order to achieve the object, the present invention provides a braking control device for controlling a braking device in a vehicle in accordance with a state of operation by a driver of the vehicle. The braking control device includes: an external recognition information acquisition unit configured to acquire external environment information of the vehicle; a vehicle information acquisition unit configured to acquire state information of the vehicle; a reference braking force calculation unit configured to calculate, based on the external environment information and the state information of the vehicle, reference braking force on an approach to a corner in a direction of travel of the vehicle; a driver-input information acquisition unit configured to acquire driver-input braking force information in the vehicle; and a braking force calculation unit configured, when receiving the input braking force information, to calculate target braking force based on the reference braking force and the input braking force information, to calculate, based on the target braking force, auxiliary braking force for reducing uneasiness felt by the driver about braking operation, and then to calculate final target braking force by using the auxiliary braking force.

### Advantageous Effects of Invention

The present invention provides a braking control device configured to apply auxiliary braking force only as needed, for example, when a travel path includes curves such as a blind corner, and configured to apply the auxiliary braking force without causing the driver to feel uneasy about the operation.

Problems, configurations, and effects other than those described above will be clarified by description of embodiments below.

### BRIEF DESCRIPTION OF DRAWINGS

FIG. 1 is an overall configuration diagram of a vehicle illustrating an example of a vehicle control system according to an embodiment.

FIG. 2 is a functional block diagram of an auxiliary braking force control device (braking control device) 11 according to the embodiment.

FIG. 3 is a functional block diagram obtained by subdividing a braking force calculation unit 107 of FIG. 2.

FIG. 4 is a flowchart of initial performance in this embodiment.

FIG. 5 is a flowchart of main performance in this embodiment.

FIG. 6 is a schematic diagram for setting processed by an auxiliary braking force ending gradient adjustment unit 207.

FIG. 7 is an operation diagram (1) when the auxiliary braking force ending gradient adjustment unit 207 operates.

FIG. 8 is an operation diagram (2) when the auxiliary braking force ending gradient adjustment unit 207 operates.

FIG. 9 is a schematic diagram for setting processed by an auxiliary braking force decreasing gradient adjustment unit 205.

FIG. 10 is an operation diagram when the auxiliary braking force decreasing gradient adjustment unit 205 operates.

FIG. 11 is a schematic diagram for setting processed by an auxiliary braking force starting gradient adjustment unit 204.

FIG. 12 is an operation diagram when the auxiliary braking force starting gradient adjustment unit 204 operates.

FIG. 13 is a schematic diagram for setting processed by an auxiliary braking force maximum output value limit unit 206.

FIG. 14 is an operation diagram when the auxiliary braking force maximum output value limit unit 206 operates.

### DESCRIPTION OF EMBODIMENTS

A braking control device according to an embodiment of the present invention will be described below with reference to the appended drawings.

### [Configuration of Vehicle]

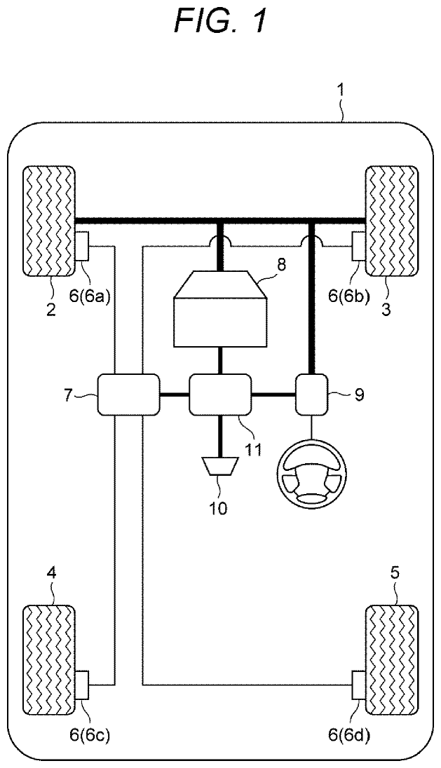

FIG. 1 is an overall configuration diagram of a vehicle illustrating an example of a vehicle control system according to the embodiment. A vehicle 1 equipped with the vehicle control system is configured to calculate, based on external environment information ahead of the vehicle 1, a target travel locus such as a corner (curve) in a direction of travel of the vehicle 1.

The vehicle 1 is a four wheel vehicle including a left front wheel 2 and a right front wheel 3 as steering wheels together with a left rear wheel 4 and a right rear wheel 5 as non-steering wheels. The vehicle 1 may be a front wheel drive system having the left front wheel 2 and the right front wheel 3 as drive wheels, a rear wheel drive system having the left rear wheel 4 and the right rear wheel 5 as the drive wheels, or a four wheel drive system having the left front, right front, left rear, and right rear wheels 2 to 5 as the drive wheels.

The vehicle 1 includes a braking device 6, a braking output control device 7, a power device 8, a steering device 9, an external recognition device 10, and an auxiliary braking force control device 11 as a braking control device of this embodiment.

Here, the power device 8 and the steering device 9 correspond to mechanisms accompanied with a traveling vehicle, and may thus not necessarily be included in this embodiment.

The braking device 6 corresponds to a mechanism to brake each of the left front, right front, left rear, and right rear wheels 2 to 5, and as a hydraulic brake system, for example, the left front, right front, left rear, and right rear wheels 2 to 5 respectively include wheel cylinders 6a, 6b, 6c, and 6d. Specifically, the left front wheel 2 includes a left front wheel cylinder 6a, the right front wheel 3 includes a right front wheel cylinder 6b, the left rear wheel 4 includes a left rear wheel cylinder 6c, and the right rear wheel 5 includes a right rear wheel cylinder 6d. Instead of the wheel cylinders 6a to 6d as hydraulic brake system, the braking device 6 may include an electric friction brake.

Note that, for convenience of configuration of the vehicle, each of the left front, right front, left rear, and right rear wheels 2 to 5 has the braking mechanism separately, but this embodiment is not limited thereto.

The braking output control device 7 controls braking output generated by the braking device 6, and functions as, for example, a hydraulic pressure adjustment unit to adjust hydraulic pressure for each of the wheel cylinders 6a to 6d. The braking output control device 7 also functions as a side slip prevention device to collect state information of the vehicle 1, such as longitudinal acceleration, lateral acceleration, and a yaw rate, from various sensors connected to the braking output control device 7, so as to prevent side slip of the vehicle 1. In order to achieve one of the functions above, the braking output control device 7 is presumably a system configured to acquire current speed of the vehicle 1 (hereinafter, also referred to as current vehicle speed) Vv, and configured to calculate presumed friction coefficient μ (hereinafter, also referred to as presumed value of road surface μ or presumed road surface μ) of a road surface on which the vehicle 1 travels. Note that, the side slip prevention device may be an independent function separate from the braking output control device 7. Further, when the braking output control device 7 is presumably a simple system that is not capable of acquiring the presumed friction coefficient μ or handling changes caused by road surface disturbance, the presumed friction coefficient μ may be a given fixed value.

The power device 8 is a power supply for drive force transmitted to at least one of the left front, right front, left rear, and right rear wheels 2 to 5 in accordance with the corresponding wheel drive system, and includes, for example, an electric motor for driving the vehicle including an engine (with an electronic control throttle) and an inverter.

The steering device 9 includes an actuator that generates steering force for steering the left front wheel 2 and the right front wheel 3, and is, for example, an electric power steering device including an electric motor as the actuator to generate the steering force.

The external recognition device 10 corresponds to external recognition means to recognize the external environment information of the vehicle 1 based on a camera, a radar, and a global positioning system (GPS), together with map information.

The auxiliary braking force control device (braking control device) 11 is communicably connected to the braking output control device 7, the power device 8, the steering device 9, and the external recognition device 10 through an in-vehicle communication line such as a control area network (CAN). The auxiliary braking force control device 11 is a vehicle travel control device configured to process information (such as the state information and the external environment information of the vehicle) input by the braking output control device 7 and the external recognition device 10, and configured to output an operation command for applying auxiliary braking force to the braking output control device 7, the power device 8, or both of the braking output control device 7 and the power device 8. The auxiliary braking force control device 11 applies the auxiliary braking force while the driver controls (manually operates) the vehicle; and even when the driver selects wrong approaching speed to an unknown road, a blind corner with poor visibility, or others in his/her braking operation, the auxiliary braking force control device 11 applies the auxiliary braking force without causing the driver to feel uneasy about operation.

### [Configuration of Auxiliary Braking Force Control Device (Braking Control Device)]

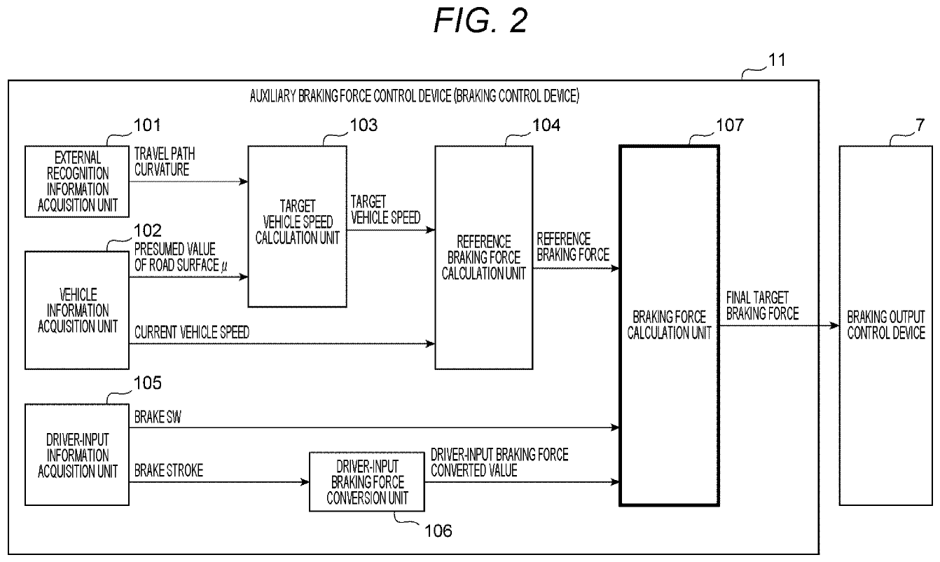

FIG. 2 is a functional block diagram of the auxiliary braking force control device (braking control device) 11 according to the embodiment. Here, sensors or controllers function for convenience in logical descriptions and thus, when mounted, may integrally function, or a single function may be shared by multiple components.

The auxiliary braking force control device 11 includes functional units as an external recognition information acquisition unit 101, a vehicle information acquisition unit 102, a target vehicle speed calculation unit 103, a reference braking force calculation unit 104, a driver-input information acquisition unit 105, a driver-input braking force conversion unit 106, and a braking force calculation unit 107. In descriptions below, each of functions of the auxiliary braking force control device 11 is performed by a processor, such as a central processing unit (CPU) of a microcomputer, that stores a control program from a read only memory (ROM) into a random access memory (RAM), but may be partially or entirely incorporated into a hardware system.

An overview will be described below with reference to reference signs in the drawings.

The external recognition information acquisition unit 101 is configured to acquire the external environment information of the vehicle 1 that is travel path information, such as travel path coordinates or travel path curvature, by using the camera, the radar, the map or the GPS (external recognition device 10).

The vehicle information acquisition unit 102 acquires the state information of the vehicle 1, such as the current vehicle speed Vv and the presumed value of road surface μ, by using a wheel speed sensor, an electronic stability control (ESC) unit, or others. In this embodiment, the vehicle information acquisition unit 102 acquires the presumed value of road surface μ from the ESC unit, but the presumed value of road surface μ may not necessarily be required.

The target vehicle speed calculation unit 103 uses, for example, a travel path curvature Kp and given target lateral acceleration YGp (e.g., the presumed road surface μ multiplied by coefficient G) to calculate target vehicle speed Vp, as expressed by Mathematical formula (1) below.

$$\begin{matrix}( Mathematical formula 1 ) & \\ Vp = √ ( YGp / Kp ) & ( 1 )\end{matrix}$$

The reference braking force calculation unit 104 calculates reference braking force based on the current vehicle speed Vv and the target vehicle speed Vp. The reference braking force is calculated, in the vehicle control system, based on the external environment information ahead of the vehicle, and specified to successfully approach to and travel along (more specifically, achieve the target vehicle speed in approaching to and travelling along) the target travel locus such as a corner (curve) in the direction of travel of the vehicle.

The driver-input information acquisition unit 105 is configured to acquire driver-input information related to the braking force (driver-input braking force information) by using a brake SW, a pedal stroke sensor, or others.

The driver-input braking force conversion unit 106 converts a value (brake stroke), which the driver inputs on the pedal stroke sensor or others, to braking force (hereinafter, also referred to as a driver-input braking force converted value). Alternatively, in some systems, the driver-input braking force conversion unit 106 may calculate the driver-input braking force converted value in other conversion methods, such as using hydraulic pressure from a master cylinder mounted on the brake system, and the hydraulic pressure is acquired by the vehicle information acquisition unit 102.

The braking force calculation unit 107 calculates braking force that is presumably insufficient (required braking force) based on the reference braking force and the driver-input braking force converted value. Then, the braking force calculation unit 107 performs a braking force adjusting process according to this embodiment to calculate the auxiliary braking force, and calculates another braking force (final target braking force) by adding the auxiliary braking force. The required braking force calculated here may also be referred to as target braking force for closing a gap between the driver-input braking force and the reference braking force. The auxiliary braking force is (supplementally) provided to the driver-input braking force while reducing uneasiness felt by the driver about the braking operation. The braking force calculation unit 107 performs main performance in this embodiment.

The braking output control device 7 outputs the braking force (final target braking force) calculated by the braking force calculation unit 107 to various actuators.

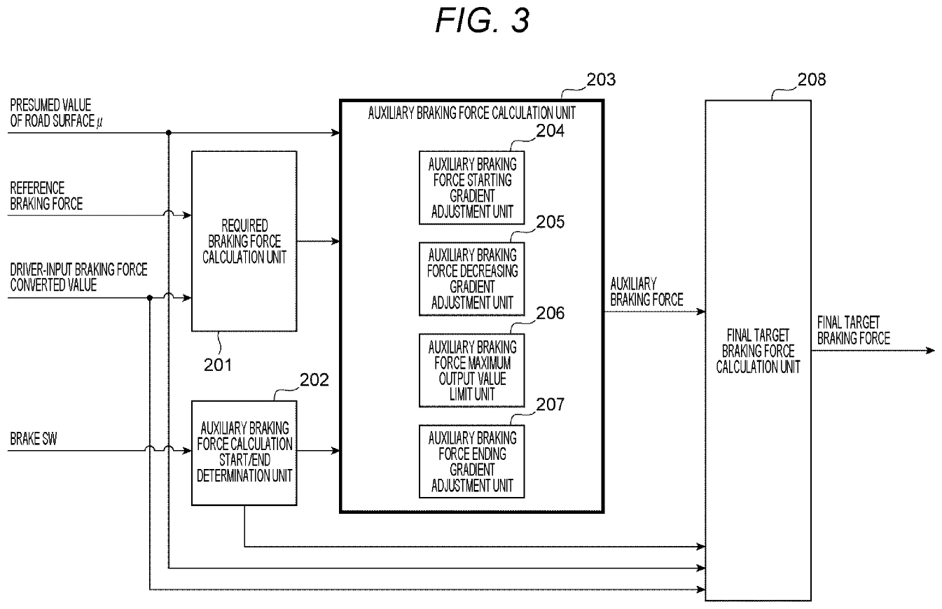

FIG. 3 is a functional block diagram obtained by subdividing the braking force calculation unit 107 of FIG. 2, and shows functions covered by the auxiliary braking force control device (braking control device) 11.

The braking force calculation unit 107 is subdivided into a required braking force calculation unit 201, an auxiliary braking force calculation start/end determination unit 202, an auxiliary braking force calculation unit 203, and a final target braking force calculation unit 208. The auxiliary braking force calculation unit 203 includes an auxiliary braking force starting gradient adjustment unit 204, an auxiliary braking force decreasing gradient adjustment unit 205, an auxiliary braking force maximum output value limit unit 206, and an auxiliary braking force ending gradient adjustment unit 207, so as to perform the braking force adjusting process.

An overview will be described below with reference to reference signs in the drawings.

The required braking force calculation unit 201 performs evaluation based on reference braking force Ap and driver-input braking force converted value Av to calculate the required braking force (target braking force).

The auxiliary braking force calculation start/end determination unit 202 determines whether or not the driver has input the braking force (i.e., whether or not the driver-input braking force information has been received) by referring to the brake SW or others, and determines whether or not to start the braking control. With this configuration, the braking control temporally synchronizes with when the driver intentionally brakes the vehicle (i.e., when the driver-input braking force information is received), so that the driver is less prone to feel uneasy about the braking behavior.

In four presumed scenes, the auxiliary braking force calculation unit 203 performs a process to reduce the uneasiness felt by the driver due to the braking control, before applying the required braking force (target braking force), and outputs the auxiliary braking force calculated in the braking force adjusting process.

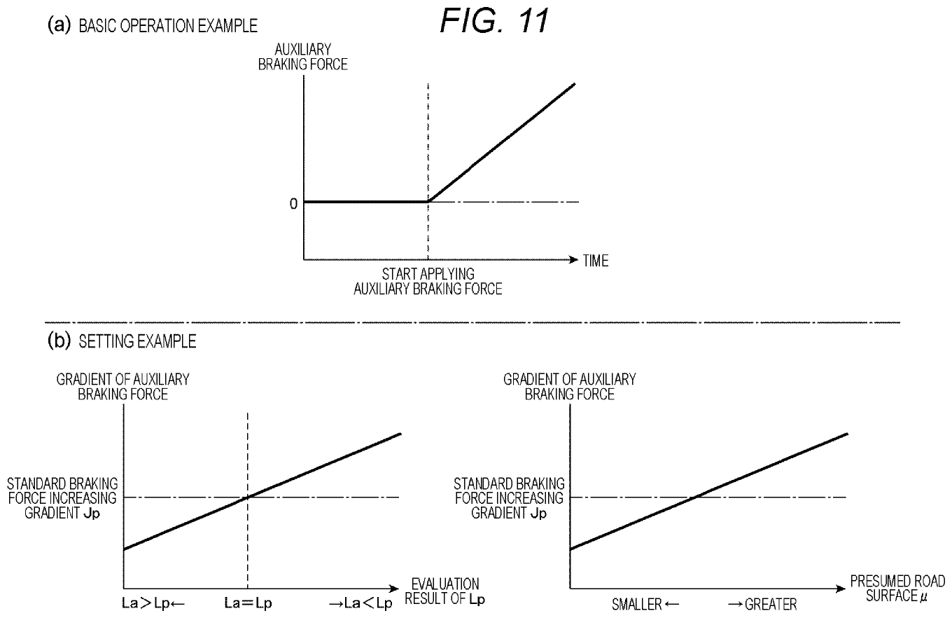

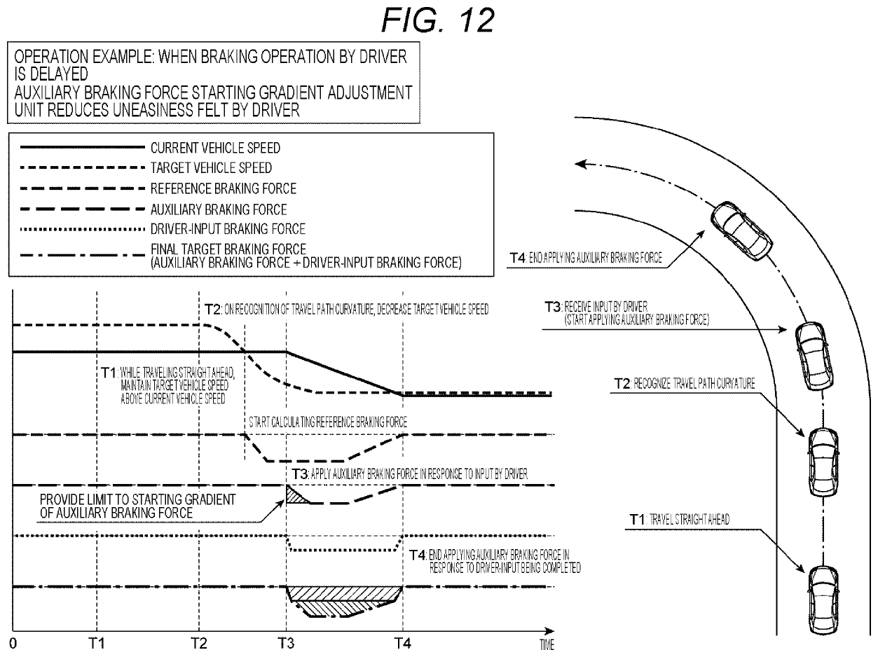

The auxiliary braking force starting gradient adjustment unit 204 adjusts a starting gradient of the auxiliary braking force to prevent the driver from feeling uneasy about the braking operation due to start of a sudden increase in deceleration (i.e., the auxiliary braking force under the braking control). In this embodiment, while being effective enough to achieve the object with a given gradient, the starting gradient may be variable based on, for example, step-in speed of a brake pedal (state of operation by the driver) acquired from the driver-input information. Alternatively, the starting gradient may be variable by following procedures below (as will be described in detail later with reference to FIGS. 11 and 12).

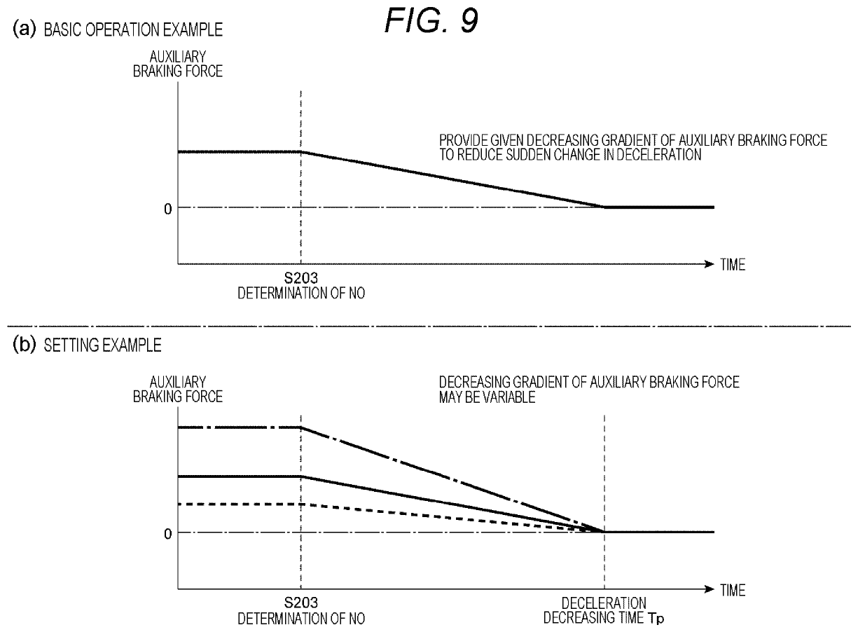

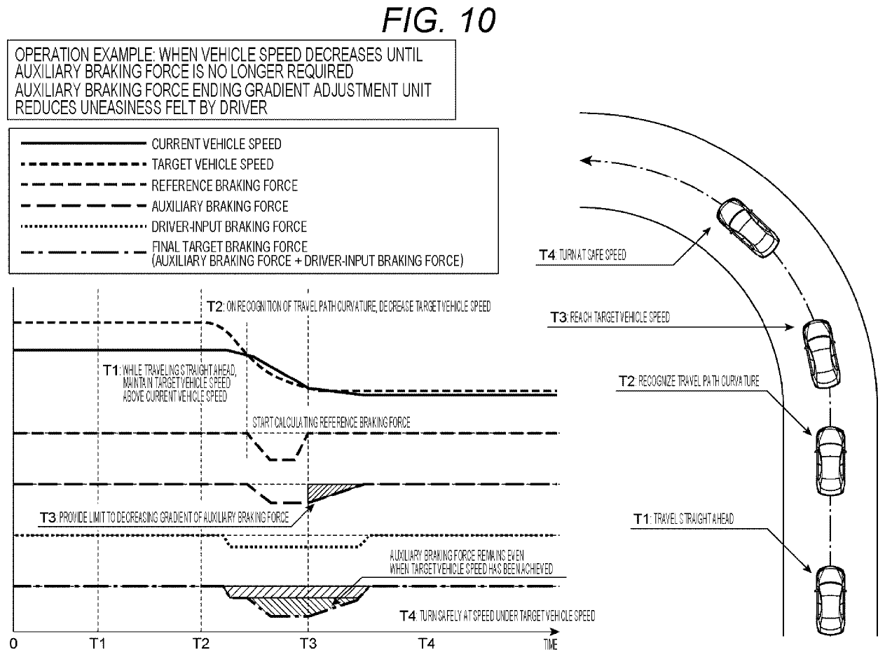

When speed of the vehicle has been sufficiently decreased to reach the target vehicle speed and the reference braking force has reached zero such that the auxiliary braking force no longer needs to be applied, the auxiliary braking force decreasing gradient adjustment unit 205 adjusts a decreasing gradient of the auxiliary braking force to prevent the driver from feeling uneasy about the braking operation due to decrease in deceleration induced by release of the braking control (i.e., due to a sudden decrease in amount of the braking control). In this embodiment, while being effective enough to achieve the object with a given gradient, the decreasing gradient may be variable based on, for example, the auxiliary braking force until immediately before the release of the braking control (i.e., decrease in deceleration) (as will be described in detail later with reference to FIGS. 9 and 10).

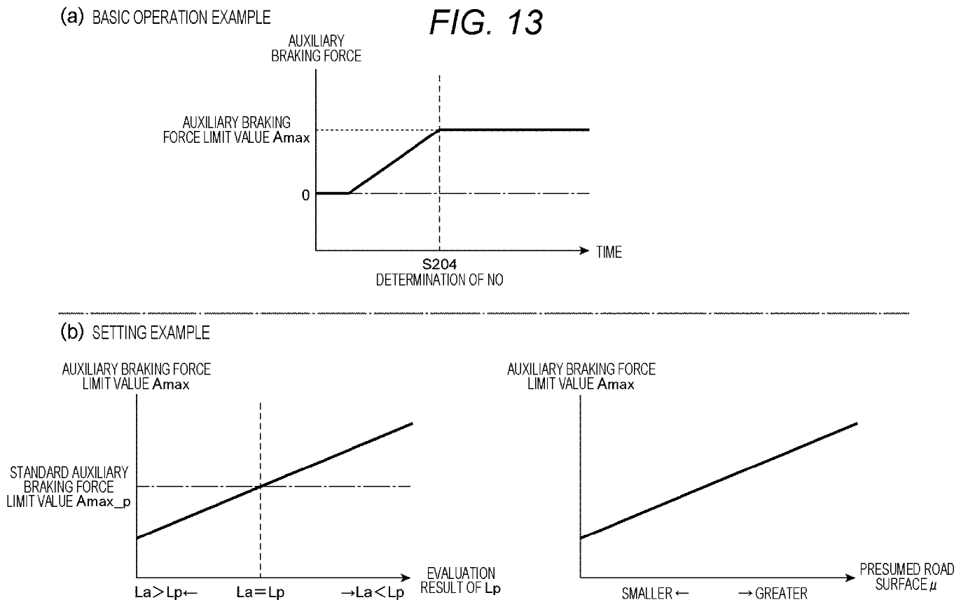

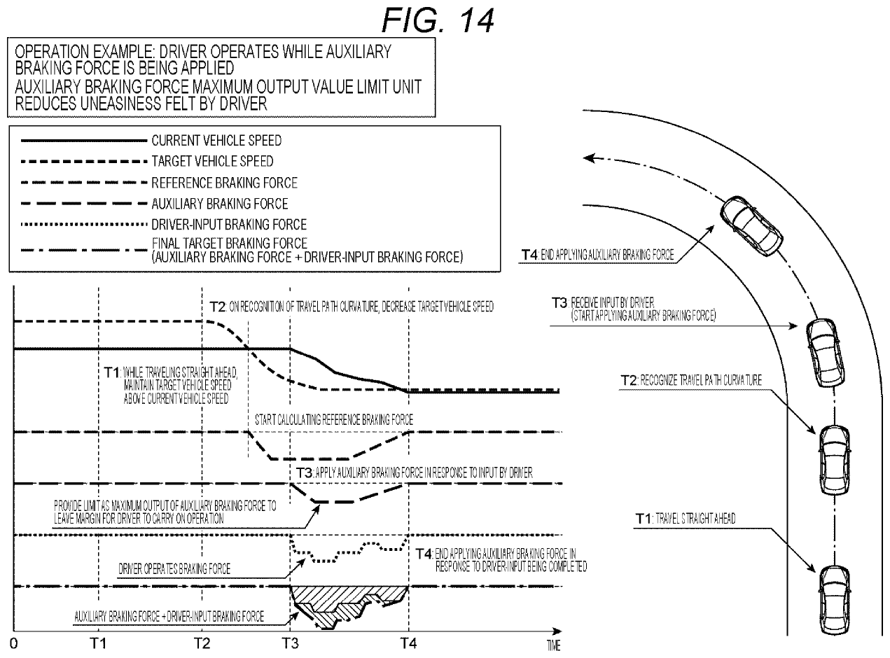

The auxiliary braking force maximum output value limit unit 206 limits a maximum output value of the auxiliary braking force to prevent the driver from feeling uneasy about the braking operation due to control failure or the like. The auxiliary braking force maximum output value limit unit 206 sets a given auxiliary braking force limit value Amax as the maximum output value of the auxiliary braking force applied under the braking control, so as to leave margin for the driver to carry on the braking operation. Here, when the auxiliary braking force limit value is set too small, the deceleration by the auxiliary braking force decreases. Thus, the auxiliary braking force limit value is preferably set as great as possible (as will be described in detail later with reference to FIGS. 13 and 14).

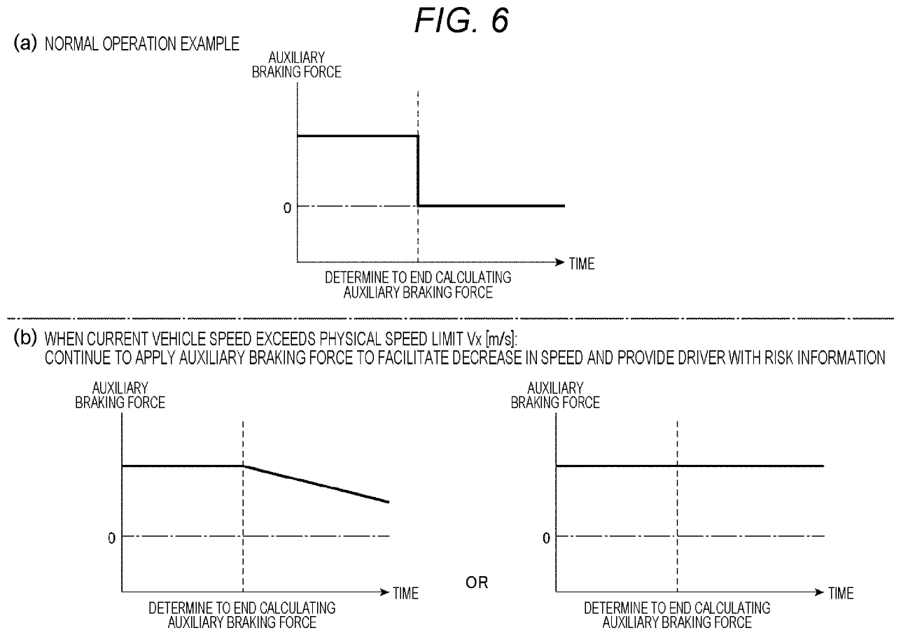

On determination that the driver has completed the input of the braking force, the auxiliary braking force ending gradient adjustment unit 207 adjusts an ending gradient of the auxiliary braking force to prevent the driver from feeling uneasy about the braking operation due to braking drag or the like (as will be described in detail later with reference to FIGS. 6, 7, and 8).

The final target braking force calculation unit 208 adds the auxiliary braking force to the driver-input braking force converted value Av to calculate the final target braking force, and outputs the final target braking force to the braking output control device 7.

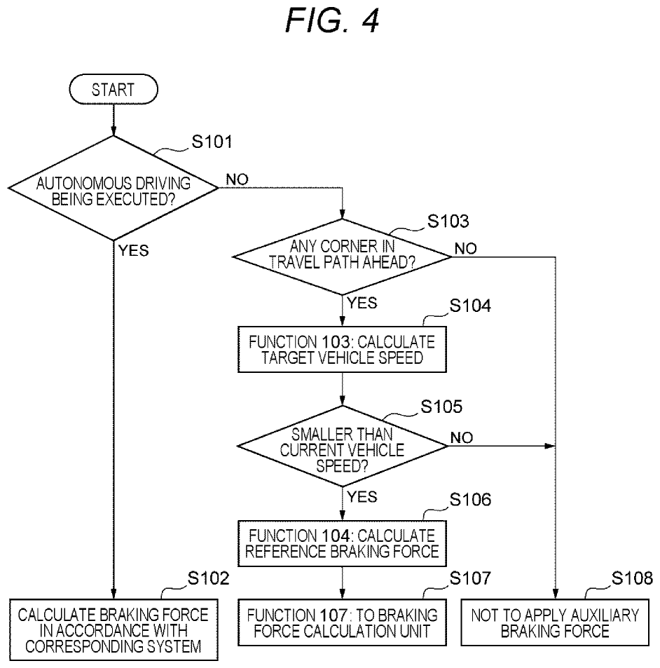

FIG. 4 is a flowchart of initial performance in this embodiment. As the initial performance in this embodiment, process steps in the flowchart of FIG. 4 are repeated in each cycle of the braking control. Further details will be described below with reference to FIG. 4.

First, in S101, the auxiliary braking force control device (braking control device) 11 determines whether or not autonomous driving or driver assistance such as adaptive cruise control (ACC) is being executed in the vehicle. This determination is made based on, for example, flag information of each of the functions acquired from the vehicle information acquisition unit 102. This process step is required because, in this embodiment, the braking control is to be performed while the driver controls (manually operates) the vehicle.

On determination of Yes (the autonomous driving or the driver assistance such as ACC is being executed) in S101, the auxiliary braking force control device (braking control device) 11 proceeds to S102 to pass the braking control over to other driver assistance system, calculate the braking force in accordance with the corresponding driver assistance system, and complete the braking control.

On determination of No in S101, the auxiliary braking force control device (braking control device) 11 proceeds to S103 to determine a state of the travel path ahead. Specifically, the auxiliary braking force control device (braking control device) 11 confirms whether or not the travel path ahead includes a corner, and makes this determination based on the travel path curvature Kp acquired from the external recognition information acquisition unit 101 in FIG. 2.

Note that, when this determination is made with reference to the travel path curvature Kp being not zero (Kp≠0), the result is likely to be Yes even when the travel path is substantially straight. Accordingly, a given threshold may be set for the determination.

On determination of No in S103, the auxiliary braking force control device (braking control device) 11 proceeds to S108 to determine that the auxiliary braking force is not required (no need to execute the auxiliary braking force function) in this embodiment and complete the braking control.

On determination of Yes in S103, the auxiliary braking force control device (braking control device) 11 proceeds to S104 to calculate the target vehicle speed. The target vehicle speed Vp may be calculated based on, for example, the travel path curvature Kp and a given target lateral acceleration YGp [m/s\hat{ }2] (e.g., the presumed road surface μ multiplied by the coefficient G), as expressed by Mathematical formula (2) (same as the Mathematical formula (1)) below. These process steps correspond to a process proceeded by the target vehicle speed calculation unit 103 in FIG. 2.

$$\begin{matrix}( Mathematical formula 2 ) & \\ Vp = √ ( YGp / Kp ) & ( 2 )\end{matrix}$$

Next, in S105, the auxiliary braking force control device (braking control device) 11 determines whether or not the target vehicle speed Vp [m/s] is smaller than the current vehicle speed Vv [m/s]. On determination of No in S105, the auxiliary braking force control device (braking control device) 11 proceeds to S108 to determine that the auxiliary braking force is not required (no need to execute the auxiliary braking force function) in this embodiment and complete the braking control.

On determination of Yes in S105, the auxiliary braking force control device (braking control device) 11 proceeds to S106 to calculate reference braking force Ap [N]. The reference braking force Ap [N] may be calculated based on, for example, a distance to corner start point Lp [m] acquired from the external recognition information acquisition unit 101 and a vehicle weight M [kg] acquired from the vehicle data, as expressed by Mathematical formula (3) below. These process steps correspond to a process proceeded by the reference braking force calculation unit 104 in FIG. 2.

$$\begin{matrix}( Mathematical formula 3 ) & \\ R p = ( Vv \hat{} 2 - Vp \hat{} 2 ) / 2 \times Lp \times M & ( 3 )\end{matrix}$$

When the reference braking force has been calculated, the auxiliary braking force control device (braking control device) 11 proceeds to S107 where the braking force calculation unit 107 in FIG. 3 operates.

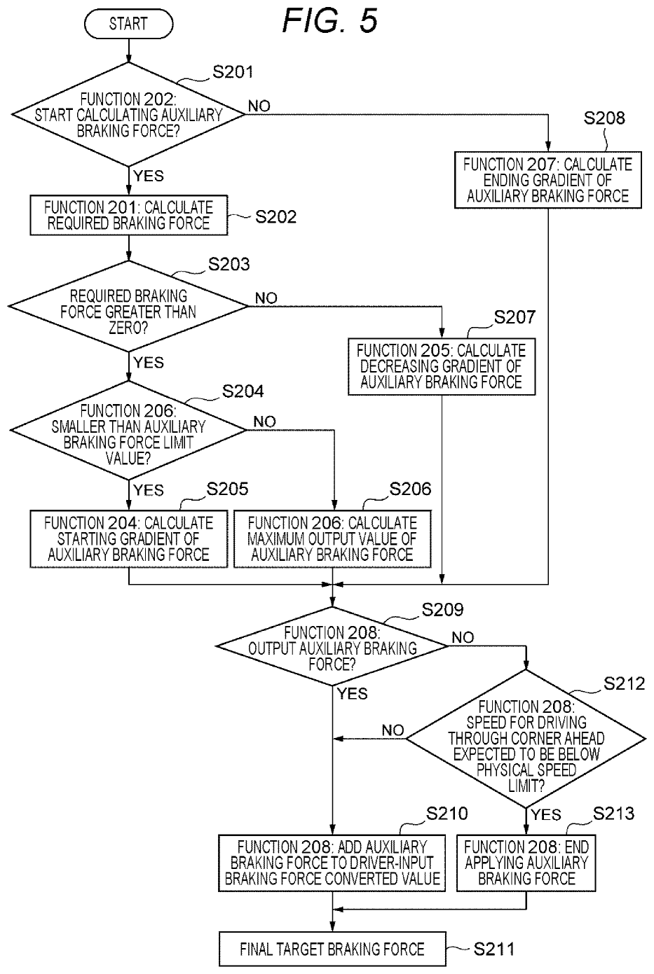

FIG. 5 is a flowchart of the main performance in this embodiment. Similarly to the initial performance in this embodiment, as the main performance in this embodiment, process steps in the flowchart of FIG. 5 are repeated in each cycle of the braking control. Further details will be described below with reference to FIG. 5.

First, the braking force calculation unit 107 determines whether or not to start calculating the auxiliary braking force in S201. Specifically, the braking force calculation unit 107 confirms whether or not the driver has completed the input of the braking force (i.e., whether or not the driver-input braking force information has been received). This operation corresponds to an operation processed by the auxiliary braking force calculation start/end determination unit 202. Here, in a simplest manner, the determination may be made based on, for example, whether or not a brake lamp switch has been turned on. Alternatively, from a viewpoint of responsiveness or operational range limit, a given threshold may be set based on information of a brake stroke sensor or the like and be used for the determination.

On determination of No in S201, the braking force calculation unit 107 proceeds to S208 to use the auxiliary braking force calculated by the auxiliary braking force ending gradient adjustment unit 207 in the auxiliary braking force calculation unit 203. The auxiliary braking force ending gradient adjustment unit 207 has a role, particularly when the driver intentionally ends the braking operation, of reducing the uneasiness felt by the driver due to a residual element of the auxiliary braking force (braking drag). As a basic mode, the auxiliary braking force calculated presumably returns to an initial zero state before a main cycle starts, as shown in, for example, “(a) normal operation example” in an upper part of FIG. 6. In other words, during the braking control, on determination, based on the driver-input braking force information, that the driver has completed the input of the braking force, the auxiliary braking force ending gradient adjustment unit 207 promptly ends the braking control even when the target braking force has not been achieved yet (even when the current vehicle speed has not been reduced to reach the target vehicle speed), and returns the auxiliary braking force to the initial zero state. With this configuration, when the operation (braking) by the driver has completed, no auxiliary braking force remains, thereby reducing the uneasiness felt by the driver due to the residual braking force (braking drag).

Here, with a system for monitoring the presumed road surface μ as in this operation example, the braking force calculation unit 107 grasps physical speed limit for driving through the corner ahead. Thus, only when the current vehicle speed Vv may exceed the physical speed limit, the braking force calculation unit 107 preferably prioritizes safety and continues to apply the auxiliary braking force. In other words, the braking force calculation unit 107 calculates the physical speed limit based on the external environment information, such as the travel path curvature, acquired by the external recognition information acquisition unit 101, together with the road surface μ information, such as the presumed road surface μ, acquired by the vehicle information acquisition unit 102. Then, only when having determined, based on comparison between the current vehicle speed acquired by the vehicle information acquisition unit 102 and the physical speed limit, that a sufficient deceleration of the vehicle 1 has not been effectively achieved, the braking force calculation unit 107 preferably continues with the braking control even when the determination has been made based on the driver-input braking force information that the driver has completed the input of the braking force.

The physical speed limit Vx [m/s] for driving through the corner ahead may be calculated based on, for example, the presumed road surface μ ([m/s\hat{ }2] converted value) Aμ [m/s\hat{ }2] and the travel path curvature Kp, as expressed by Mathematical formula (4) below.

$$\begin{matrix}( Mathematical formula 4 ) & \\ Vx = √ ( A μ / Kp ) & ( 4 )\end{matrix}$$

The presumed road surface μ ([m/s\hat{ }2] converted value) Aμ [m/s\hat{ }2] is a presumed value, and may thus be calculated by multiplying a margin coefficient k to avoid wrong calculation, as expressed by Mathematical formula (5) below. Note that, the value to be set here is greater than the given target lateral acceleration YGp [m/s\hat{ }2] used for calculating the target vehicle speed Vp [m/s].

$$\begin{matrix}( Mathematical formula 5 ) & \\ Vx = √ ( A μ / Kp \times k ) & ( 5 )\end{matrix}$$

With the physical speed limit Vx [m/s] used as the threshold for the determination, as shown in, for example, a lower part of FIG. 6 “(b) when the current vehicle speed exceeds the physical speed limit Vx [m/s]”, the braking force calculation unit 107 sets the given gradient of deceleration (auxiliary braking force) or maintains the auxiliary braking force such that the braking force remains. Then, the braking force calculation unit 107 facilitates the current vehicle speed to decrease to reach the physical speed limit Vx [m/s] and effectively warns the driver by causing the driver to feel uneasy about the braking operation, so as to reduce risks (specifically, occurrences of vehicle behavior such as understeering or oversteering) in response to overspeeding when the vehicle turns.

With this configuration, it is possible to reduce the uneasiness felt by the driver about the braking operation within a normal range, and concurrently possible to reduce the risks.

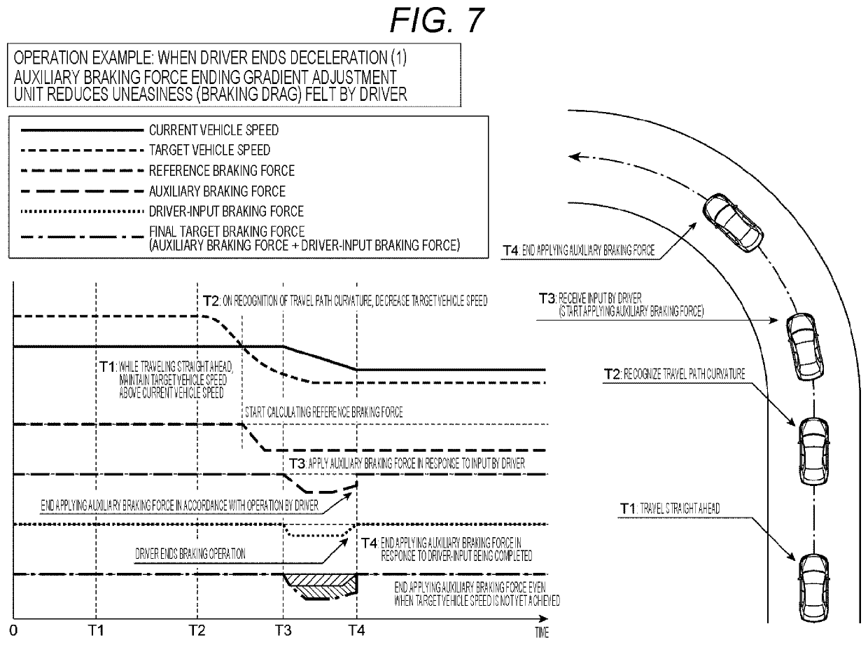

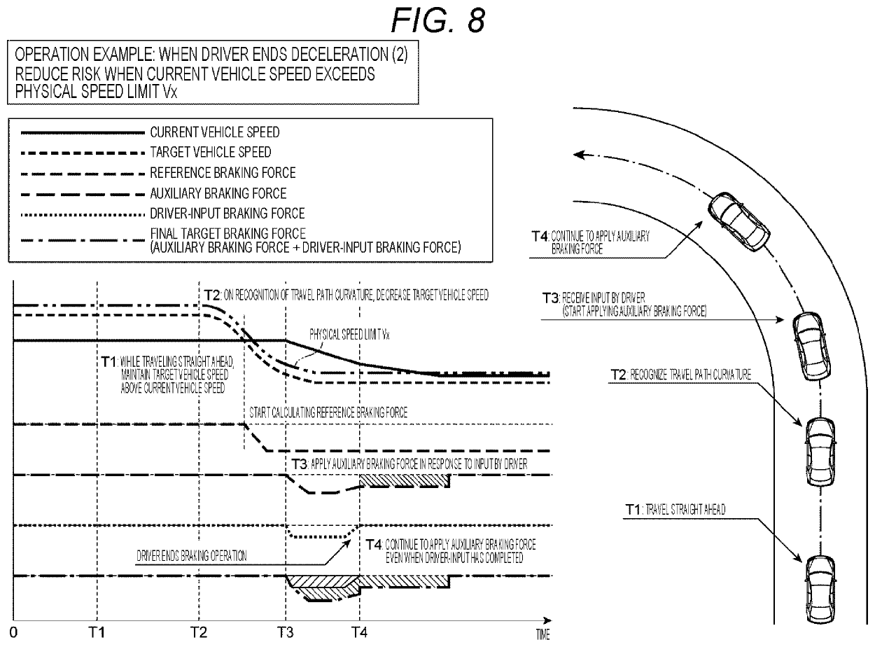

Each of FIGS. 7 and 8 is an operation diagram when the auxiliary braking force ending gradient adjustment unit 207 operates.

FIG. 7 shows a basic operation of this function, and the driver completes the braking operation at point T4. In this state, the target braking force has not been achieved yet and the current vehicle speed has not been reduced to reach the target vehicle speed, but the braking force calculation unit 107 prioritizes reducing the uneasiness felt by the driver about the braking operation and ends the braking control, that is, ends applying the auxiliary braking force (returns the auxiliary braking force to the initial zero state). This results in higher speed when the vehicle turns, but the braking control promptly ends without causing the driver to feel uneasy due to the braking drag.

Next, the operation diagram of FIG. 8 will be described.

In this operation example, the driver completes the braking operation at the point T4 as in FIG. 7. However, at this point, based on comparison between the current vehicle speed and the physical speed limit Vx for driving through the corner ahead, the braking force calculation unit 107 determines that the sufficient deceleration of the vehicle 1 has not been effectively achieved, that the current vehicle speed exceeds the physical speed limit Vx for driving through the corner ahead, and that the vehicle is thus in a state of having the risk of occurrence of vehicle behavior such as understeering or oversteering unless the current vehicle speed is reduced. In this case, the braking force calculation unit 107 prioritizes safety over the uneasiness felt by the driver, and continues with the braking control to apply the auxiliary braking force. This effectively reduces the speed of the vehicle and concurrently, provides the driver with risk information by causing the driver to feel uneasy about the braking operation.

Next, returning to FIG. 5, on determination of Yes in S201, the braking force calculation unit 107 proceeds to S202 to calculate required braking force As. The required braking force As may be calculated based on, for example, the reference braking force Ap and the driver-input braking force converted value Av, as expressed by Mathematical formula (6) below. These process steps correspond to a process proceeded by the required braking force calculation unit 201 in FIG. 3.

$$\begin{matrix}( Mathematical formula 6 ) & \\ As = Ap - Av & ( 6 )\end{matrix}$$

Next, the braking force calculation unit 107 proceeds to determination in S203. In S203, the braking force calculation unit 107 confirms whether or not the required braking force is identified (whether or not the required braking force is greater than zero). On determination of No in S203, the braking force calculation unit 107 proceeds to S207 to use the auxiliary braking force calculated by the auxiliary braking force decreasing gradient adjustment unit 205 in the auxiliary braking force calculation unit 203. When, before the main cycle starts, the auxiliary braking force has been applied (the braking control has been executed) to sufficiently decrease the speed of the vehicle to fall below the target vehicle speed Vp and cause the reference braking force to reach zero, the auxiliary braking force decreasing gradient adjustment unit 205 has a role of reducing the uneasiness felt by the driver about the braking operation (such as going out of gear) due to a sudden change in deceleration (amount of the braking control) induced by step-by-step process of ending the auxiliary braking force.

For example, the auxiliary braking force decreasing gradient adjustment unit 205 sets a given decreasing gradient of the auxiliary braking force as shown in “(a) normal operation example” in an upper part of FIG. 9. When the auxiliary braking force stops being applied (the braking control stops being executed), the auxiliary braking force decreasing gradient adjustment unit 205 smooths out a decelerating jerk as a change in speed of deceleration to reduce the sudden change in deceleration (amount of braking control). In other words, when the braking control has sufficiently decreased the speed of the vehicle and the reference braking force has reached zero, the auxiliary braking force decreasing gradient adjustment unit 205 sets the decreasing gradient of the auxiliary braking force until the end of the braking control, and limits (calculates the auxiliary braking force to limit) the sudden change in amount of the braking control.

In this embodiment, due to a mild change in inclination of the decreasing gradient, the driver is less likely to be sensitive about the change in deceleration. On the other hand, when an unwanted period of time is spent, unwanted auxiliary braking force is continuously applied, which causes an unwanted decrease in speed and causes the driver to feel uneasy. Thus, as in “(b) setting example” in a lower part of FIG. 9, for example, a deceleration decreasing time Tp may be set, and the inclination (decreasing gradient) may be variable in accordance with the state of applying the auxiliary braking force when the determination is made in S203 (at time of release of the braking control or the decrease in deceleration). In other words, the auxiliary braking force decreasing gradient adjustment unit 205 may change the decreasing gradient of the auxiliary braking force until the end of the braking control, in accordance with the state of applying the auxiliary braking force until immediately before the auxiliary braking force decreases (the deceleration decreases).

FIG. 10 is an operation diagram when the auxiliary braking force decreasing gradient adjustment unit 205 operates.

In this operation example, at point T3, the speed of the vehicle has been sufficiently decreased such that the current vehicle speed reaches the target vehicle speed, and the reference braking force has reached zero. Here, the auxiliary braking force is no longer required. In this state, the auxiliary braking force decreasing gradient adjustment unit 205 gradually decreases the deceleration (amount of the braking control) using the decreasing gradient of the auxiliary braking force until the end of the braking control, instead of ending the auxiliary braking force step by step. This causes the current vehicle speed to continuously decrease, while reducing the uneasiness felt by the driver about the braking operation due to the sudden change in deceleration (amount of the braking control).

Next, returning to FIG. 5, on determination of Yes in S203, the braking force calculation unit 107 proceeds to S204 to determine whether or not the auxiliary braking force is applied in the main cycle in a smaller amount than the auxiliary braking force limit value (maximum output value of the auxiliary braking force) calculated by the auxiliary braking force maximum output value limit unit 206. The process of S204 may not be included when the auxiliary braking force maximum output value limit unit 206 does not operate in the braking control.

On determination of Yes in S204, the braking force calculation unit 107 proceeds to S205 to use the auxiliary braking force calculated by the auxiliary braking force starting gradient adjustment unit 204 in the auxiliary braking force calculation unit 203. The auxiliary braking force starting gradient adjustment unit 204 functions to reduce uneasiness and discomfort felt by the driver particularly at the start due to the sudden increase in deceleration (i.e., the auxiliary braking force under the braking control) occurring particularly at the start.

For example, the auxiliary braking force starting gradient adjustment unit 204 sets a given starting gradient of the auxiliary braking force as shown in “(a) normal operation example” in an upper part of FIG. 11, and gradually increases the auxiliary braking force to reduce the sudden increase in deceleration immediately after the auxiliary braking force control starts. In other words, when the braking control is performed based on the target braking force, the auxiliary braking force starting gradient adjustment unit 204 limits the starting gradient of the auxiliary braking force induced by the braking control.

In this embodiment, due to a mild change in inclination of the starting gradient, the driver is less likely to be sensitive about the sudden change in deceleration, while the auxiliary braking force applied (the braking control executed) decreases the speed of the vehicle, leading to a trade-off situation. Thus, in some travel states, the inclination (starting gradient) may preferably be changed in accordance with a degree of need.

For example, the auxiliary braking force starting gradient adjustment unit 204 may set a standard braking force increasing gradient Jp, and may use the current vehicle speed Vv [m/s], the target vehicle speed Vp [m/s], and a given ideal deceleration Ap [m/s\hat{ }2] to calculate a theoretical value La [m] to reach the target vehicle speed, as expressed by Mathematical formula (7) below. Then, based on comparison between the theoretical value La [m] to reach the target vehicle speed and the distance to corner start point Lp [m], the auxiliary braking force starting gradient adjustment unit 204 may change the starting gradient, so that reducing the uneasiness felt by the driver and reducing the speed of the vehicle are alternately and continuously prioritized.

$$\begin{matrix}( Mathematical formula 7 ) & \\ La = ( Vv \hat{} 2 - Vp \hat{} 2 ) / ( 2 \times Ap ) & ( 7 )\end{matrix}$$

Further, when traveling on a slippery road surface such as a wet or frozen road surface, the sudden increase in deceleration may induce a risk of slipping of the vehicle (specifically, understeering or oversteering due to a locked wheel or turning of the vehicle). Accordingly, with the presumed road surface μ acquired, the auxiliary braking force starting gradient adjustment unit 204 may, for example, change the standard braking force increasing gradient Jp in accordance with the presumed road surface μ to reduce the risk of slipping of the vehicle. The “(b) setting example” in a lower part of FIG. 11 shows an example of a mechanism to vary the starting gradient of the auxiliary braking force. In other words, the auxiliary braking force starting gradient adjustment unit 204 may change the starting gradient of the auxiliary braking force induced by the braking control, in accordance with the current vehicle speed, the road surface P information (presumed road surface μ), the external environment information including the travel path curvature, and the state of operation by the driver.

Note that, the mechanisms described above are each not designed to function alone, and thus may be combined.

FIG. 12 is an operation diagram when the auxiliary braking force starting gradient adjustment unit 204 operates.

In this operation example, when the vehicle has driven past point T2, the target vehicle speed falls below the current vehicle speed, based on which the determination is made that the auxiliary braking force is required. Here, the auxiliary braking force starts being applied (the braking control starts being executed) in response to the braking operation by the driver (driver-input braking force) at point T3. In this state, the driver-input braking force has a gap from the required braking force. The auxiliary braking force starting gradient adjustment unit 204 adjusts the starting gradient, instead of applying the auxiliary braking force step by step, so that the auxiliary braking force with the adjusted starting gradient (limited auxiliary braking force) is applied. This reduces the sudden increase in deceleration immediately after the auxiliary braking force control starts (i.e., the sudden increase in auxiliary braking force induced by the braking control), and thus reduces the uneasiness felt by the driver about the braking operation.

Returning to FIG. 5, on determination of No in S204, the braking force calculation unit 107 proceeds to S206 to use the auxiliary braking force calculated by the auxiliary braking force maximum output value limit unit 206 in the auxiliary braking force calculation unit 203. When the auxiliary braking force is continuously applied (the braking control is continuously executed), the continuous increase in auxiliary braking force causes the braking control device to take over control from the driver, which reduces a range operable by the driver and causes the driver to feel uneasy about the braking operation. In this state particularly, the auxiliary braking force maximum output value limit unit 206 has a role of reducing the uneasiness felt by the driver. Concurrently, when the reference braking force is greater than the driver-input braking force, the required braking force increases. Here, the auxiliary braking force is applied in greater amount, which may cause the driver to be more sensitive about the braking operation and feel uneasy. With this function, however, the driver is likely to feel less uneasy.

Specifically, as shown in “(a) normal operation example” in an upper part of FIG. 13, the auxiliary braking force maximum output value limit unit 206 sets the given auxiliary braking force limit value Amax for the auxiliary braking force used in a scene where the required braking force continuously increases, so as to leave the margin for the driver to carry on the braking operation. This method allows the driver to maintain feeling of operating the vehicle. With the margin left for the driver to carry on, the braking force remains responsive to the operation by the driver, thereby reducing the uneasiness felt by the driver about his/her braking operation. In other words, when the braking control is performed based on the target braking force, the auxiliary braking force maximum output value limit unit 206 sets the auxiliary braking force limit value Amax to limit the maximum output value of the auxiliary braking force applied under the braking control.

Here, when the auxiliary braking force limit value Amax is set smaller, the driver is less likely to feel uneasy about the operation, while the auxiliary braking force applied (the braking control executed) decreases the speed of the vehicle, leading to a trade-off situation. This is similar to the case of the auxiliary braking force starting gradient adjustment unit 204. Thus, in some travelling states, the auxiliary braking force limit value Amax may preferably be changed in accordance with a degree of need.

For example, the auxiliary braking force maximum output value limit unit 206 may set a standard auxiliary braking force limit value Amax_p, and by using the current vehicle speed Vv [m/s], the target vehicle speed Vp [m/s], and the given ideal deceleration Ap [m/s\hat{ }2], may calculate the theoretical value La [m] to reach the target vehicle speed, as expressed by Mathematical formula (8) below (same as the Mathematical formula (7)). Then, based on comparison between the theoretical value La [m] to reach the target vehicle speed and the distance to corner start point Lp [m], the auxiliary braking force maximum output value limit unit 206 may vary the auxiliary braking force limit value Amax, so that reducing the uneasiness felt by the driver and reducing the speed of the vehicle are alternately and continuously prioritized.

$$\begin{matrix}( Mathematical formula 8 ) & \\ La = ( Vv \hat{} 2 - Vp \hat{} 2 ) / ( 2 \times Ap ) & ( 8 )\end{matrix}$$

Further, when traveling on a slippery road surface such as a wet or frozen road surface, the maximum deceleration on the slippery road surface may change. With the auxiliary braking force limit value Amax being uniform, a ratio of the range covered by the auxiliary braking force to the range operable by the driver is to vary, and the expected effect may not be achieved. Here, with the presumed road surface μ acquired, the auxiliary braking force maximum output value limit unit 206 may, for example, change the auxiliary braking force limit value Amax in accordance with the presumed road surface μ to sustain the ratio and achieve the expected effect regardless of road surface conditions. The “(b) setting example” in a lower part of FIG. 13 shows the setting method described above. In other words, similarly to the auxiliary braking force starting gradient adjustment unit 204, the auxiliary braking force maximum output value limit unit 206 may increase or decrease the auxiliary braking force limit value Amax as the maximum output value of the auxiliary braking force, in accordance with the current vehicle speed, the road surface μ information (presumed road surface μ), the external environment information including the travel path curvature, and the state of operation by the driver.

Note that, the mechanisms described above are each not designed to function alone, and thus may be combined.

The auxiliary braking force maximum output value limit unit 206 has the varying mechanism above, but due to repeated changes during the operation, the amount of control in auxiliary braking force may be unstable and may not allow driver to maintain the feeling of operating the vehicle. Accordingly, the auxiliary braking force limit value Amax, which has been corrected, may be preferably specified at point of, for example, S201 in an initial cycle.

FIG. 14 is an operation diagram when the auxiliary braking force maximum output value limit unit 206 operates.

In this operation example, the auxiliary braking force starts being applied (the braking control starts being executed) at point T3, undergoes the “starting gradient of the auxiliary braking force” generated by the auxiliary braking force starting gradient adjustment unit 204, and is maintained based on the “auxiliary braking force limit value Amax” set, while the margin for the driver to carry on the braking operation still remains. With this configuration, the braking control system is not unresponsive to the increase or decrease in braking operation by the driver but remains responsive, while “increased” elements of the auxiliary braking force are kept. Accordingly, the driver feels less uneasy about his/her braking operation.

Returning to FIG. 5, when the process steps of S205, S206, S207, and S208 (corresponding to the auxiliary braking force starting gradient adjustment unit 204, the auxiliary braking force maximum output value limit unit 206, the auxiliary braking force decreasing gradient adjustment unit 205, and the auxiliary braking force ending gradient adjustment unit 207, each included in the auxiliary braking force calculation unit 203) have been completed, the braking force calculation unit 107 proceeds to S209 to determine whether or not to output the auxiliary braking force. This operation corresponds to an operation processed by the final target braking force calculation unit 208 (and as do the subsequent operations in S210, S212, and S213). Here, in a simplest manner, the determination may be made based on, for example, whether or not the brake lamp switch has been turned on. Alternatively, from the viewpoint of responsiveness or operational range limit, a given threshold may be set based on the information of the brake stroke sensor or the like and be used for the determination. In the braking control, the determination above is similar to that in S201, but the given threshold may be used to vary timing for calculation and timing for output, initialize setting of each gradient, and others.

On determination of Yes in S209, the braking force calculation unit 107 proceeds to S210 to add the auxiliary braking force calculated to the driver-input braking force converted value, and proceeds to S211 to output the final target braking force to the actuator (braking output control device 7).

On determination of No in S209, the braking force calculation unit 107 proceeds to S212 to determine whether or not the speed for driving through the corner is expected to be below the physical speed limit.

The physical speed limit Vx [m/s] for driving through the corner ahead may be calculated based on, for example, the presumed road surface μ ([m/s\hat{ }2] converted value) Aμ [m/s\hat{ }2] and the travel path curvature Kp, as expressed by Mathematical formula (9) below (same as the Mathematical formula (4)).

$$\begin{matrix}( Mathematical formula 9 ) & \\ Vx = √ ( A μ / Kp ) & ( 9 )\end{matrix}$$

The presumed road surface μ ([m/s\hat{ }2] converted value) Aμ [m/s\hat{ }2] is the presumed value, and may thus be calculated by multiplying a margin coefficient c to avoid wrong calculation, as expressed by Mathematical formula (10) below. Note that, the value to be set here is greater than the given target lateral acceleration YGp [m/s\hat{ }2] used for calculating the target vehicle speed Vp [m/s], and is equal to or smaller than the margin coefficient k (see the Mathematical formula (5)) used for calculation by the final target braking force calculation unit 208.

$$\begin{matrix}( Mathematical formula 10 ) & \\ Vx = √ ( A μ / Kp \times c ) & ( 10 )\end{matrix}$$

On determination of No in S212, the braking force calculation unit 107 proceeds to S210 to prioritize safety and continue to apply the auxiliary braking force.

On determination of Yes in S212, the braking force calculation unit 107 proceeds to S213 to end applying the auxiliary braking force.

Here, the functional blocks as the auxiliary braking force starting gradient adjustment unit 204, the auxiliary braking force decreasing gradient adjustment unit 205, the auxiliary braking force maximum output value limit unit 206, and the auxiliary braking force ending gradient adjustment unit 207 may not necessarily have all the functions above but have any one or more of these functions.

As has been described above, the auxiliary braking force control device (braking control device) 11 according to this embodiment is a braking control device for controlling the braking device 6 in the vehicle 1 in accordance with the state of operation by the driver. The auxiliary braking force control device (braking control device) 11 includes: the external recognition information acquisition unit 101 configured to acquire the external environment information of the vehicle 1; the vehicle information acquisition unit 102 configured to acquire the state information of the vehicle 1; the reference braking force calculation unit 104 configured to calculate, based on the external environment information and the state information of the vehicle 1, the reference braking force on an approach to the corner (curve) in the direction of travel of the vehicle 1; the driver-input information acquisition unit 105 configured to acquire the driver-input braking force information (driver-input information related to the braking force) in the vehicle 1; and the braking force calculation unit 107 configured, when receiving the input braking force information, to calculate the target braking force based on the reference braking force and the input braking force information (driver-input braking force converted value), to calculate, based on the target braking force, the auxiliary braking force for reducing the uneasiness (performing the process to reduce the uneasiness) felt by the driver about the braking operation, and then to calculate the final target braking force by using the auxiliary braking force (adding the auxiliary braking force to the driver-input braking force converted value).

When the braking control is performed based on the target braking force, the braking force calculation unit 107 limits the starting gradient of the auxiliary braking force induced by the braking control (auxiliary braking force starting gradient adjustment unit 204). In this case, the braking force calculation unit 107 includes the mechanism to change the starting gradient of the auxiliary braking force induced by the braking control, in accordance with the current vehicle speed and the road surface P information (presumed road surface μ), each acquired by the vehicle information acquisition unit 102, the external environment information, such as the travel path curvature, acquired by the external recognition information acquisition unit 101, and the state of operation by the driver acquired by the driver-input information acquisition unit 105.

When, due to the braking control, the speed of the vehicle has been sufficiently decreased and the reference braking force has reached zero, the braking force calculation unit 107 sets the decreasing gradient of the auxiliary braking force until the end of the braking control, and limits the sudden change in amount of the braking control (auxiliary braking force decreasing gradient adjustment unit 205). In this case, the braking force calculation unit 107 includes the mechanism to change the decreasing gradient of the auxiliary braking force until the end of the braking control, in accordance with the state of applying the auxiliary braking force until immediately before the auxiliary braking force decreases (the deceleration decreases).

When the braking control is performed based on the target braking force, the braking force calculation unit 107 limits the maximum output value of the auxiliary braking force applied under the braking control (auxiliary braking force maximum output value limit unit 206). In this case, the braking force calculation unit 107 includes the mechanism to increase or decrease the auxiliary braking force limit value as the maximum output value of the auxiliary braking force, in accordance with the current vehicle speed and the road surface μ information (presumed road surface μ), each acquired by the vehicle information acquisition unit 102, the external environment information, such as the travel path curvature, acquired by the external recognition information acquisition unit 101, and the state of operation by the driver acquired by the driver-input information acquisition unit 105.

During the braking control, on the determination, based on the driver-input braking force information, that the driver has completed the input of the braking force, the braking force calculation unit 107 promptly ends the braking control even when the target braking force has not been achieved yet (auxiliary braking force ending gradient adjustment unit 207). In this case, the braking force calculation unit 107 calculates the physical speed limit based on the external environment information, such as the travel path curvature, acquired by the external recognition information acquisition unit 101, together with the road surface μ information acquired by the vehicle information acquisition unit 102. Then, only when having determined, based on the comparison between the current vehicle speed acquired by the vehicle information acquisition unit 102 and the physical speed limit, that the sufficient deceleration of the vehicle 1 has not been effectively achieved, the braking force calculation unit 107 continues with the braking control even when the determination has been made based on the driver-input braking force information that the driver has completed the input of the braking force.

The auxiliary braking force control device (braking control device) according to this embodiment applies the auxiliary braking force only as needed, for example, when the travel path includes the curves such as blind corners, and applies the auxiliary braking force without causing the driver to feel uneasy about the operation.

In other words, in this embodiment, when the driver controls (manually operates) the vehicle and when the system (control system) continues to control the speed of the vehicle, the driver may feel uneasy or uncomfortable. This requires a technique for providing the auxiliary braking force without causing the driver to feel uneasy. The auxiliary braking force control device (braking control device) 11 of this embodiment calculates logical braking force used for the autonomous driving, based on which the auxiliary braking force control device (braking control device) 11 selects, by referring to the state of the travel path ahead of the vehicle and the state of braking operation by the driver, a scene where the auxiliary braking force is required, so as to perform the braking control. Further, the auxiliary braking force control device (braking control device) 11 has the mechanism (the auxiliary braking force starting gradient adjustment unit 204, the auxiliary braking force decreasing gradient adjustment unit 205, the auxiliary braking force maximum output value limit unit 206, and the auxiliary braking force ending gradient adjustment unit 207 included in the auxiliary braking force calculation unit 203) to reduce the uneasiness felt by the driver, such as adjusting the gradients of the auxiliary braking force in deceleration, so as to provide auxiliary control for the speed (deceleration) of the vehicle without causing the driver to feel uneasy.

The present invention is not limited to the foregoing embodiments, and various modifications may be included. For example, the detailed description of each of configurations in the foregoing embodiments is to be considered in all respects as merely illustrative for convenience of description, and thus is not restrictive.

Each of the components, functions, processing units, processes, or others in the foregoing embodiments may be partially or wholly incorporated into a hardware system, such as an integrated circuit design. Further, each of the components, the functions, or others may be incorporated into a software system where a processor interprets and executes a program regarding each of the functions. Information indicating each of the functions, such as a program, a table or a file, may be stored in a storage device such as a memory, a hard disk, or a solid state drive (SSD). The information may alternatively be stored in a storage medium such as an IC card, an SD card or a DVD.

Further, each of a control line and an information line is considered to be necessary for description purposes, and thus does not represent all the control lines or information lines of the product. Practically, it is to be understood that substantially all components are connected to each other.

### REFERENCE SIGNS LIST

1 vehicle
2 to 5 wheel
6 (6a to 6d) braking device such as hydraulic brake
7 braking output control device such as side slip prevention device
8 power device such as engine and electric motor
9 steering device such as electric power steering device
10 external recognition device such as camera and GPS
11 auxiliary braking force control device (braking control device)
101 external recognition information acquisition unit
102 vehicle information acquisition unit
103 target vehicle speed calculation unit
104 reference braking force calculation unit
105 driver-input information acquisition unit
106 driver-input braking force conversion unit
107 braking force calculation unit
201 required braking force calculation unit
202 auxiliary braking force calculation start/end determination unit
203 auxiliary braking force calculation unit
204 auxiliary braking force starting gradient adjustment unit
205 auxiliary braking force decreasing gradient adjustment unit
206 auxiliary braking force maximum output value limit unit
207 auxiliary braking force ending gradient adjustment unit
208 final target braking force calculation unit
S101 to S108 each step of overall control flow
S201 to S213 each step of control flow by braking force calculation unit

1. A braking control device for controlling a braking device in a vehicle in accordance with a state of operation by a driver of the vehicle, the braking control device comprising:
an external recognition information acquisition unit configured to acquire external environment information of the vehicle;
a vehicle information acquisition unit configured to acquire state information of the vehicle;
a reference braking force calculation unit configured to calculate, based on the external environment information and the state information of the vehicle, reference braking force on an approach to a corner in a direction of travel of the vehicle;
a driver-input information acquisition unit configured to acquire driver-input braking force information in the vehicle; and
a braking force calculation unit configured, when receiving the input braking force information, to calculate target braking force based on the reference braking force and the input braking force information, to calculate, based on the target braking force, auxiliary braking force for reducing uneasiness felt by the driver about braking operation, and then to calculate final target braking force by using the auxiliary braking force.

2. The braking control device according to claim 1, wherein when braking control is performed based on the target braking force, the braking force calculation unit limits a starting gradient of the auxiliary braking force induced by the braking control.

3. The braking control device according to claim 1, wherein when, due to the braking control executed, speed of the vehicle has been sufficiently decreased and the reference braking force has reached zero, the braking force calculation unit sets a decreasing gradient of the auxiliary braking force until end of the braking control, and limits a sudden change in amount of the braking control.

4. The braking control device according to claim 1, wherein when the braking control is performed based on the target braking force, the braking force calculation unit limits a maximum output value of the auxiliary braking force applied under the braking control.

5. The braking control device according to claim 1, wherein during the braking control, on determination, based on the driver-input braking force information, that the driver has completed input of the braking force, the braking force calculation unit promptly ends the braking control even when the target braking force has not been achieved yet.

6. The braking control device according to claim 2, wherein the braking force calculation unit includes a mechanism to change the starting gradient of the auxiliary braking force induced by the braking control, in accordance with current vehicle speed and road surface μ information, each acquired by the vehicle information acquisition unit, the external environment information, such as travel path curvature, acquired by the external recognition information acquisition unit, and the state of operation by the driver acquired by the driver-input information acquisition unit.

7. The braking control device according to claim 3, wherein the braking force calculation unit includes a mechanism to change the decreasing gradient of the auxiliary braking force until the end of the braking control, in accordance with a state of applying the auxiliary braking force until immediately before the auxiliary braking force decreases.

8. The braking control device according to claim 4, wherein the braking force calculation unit includes a mechanism to increase or decrease an auxiliary braking force limit value as the maximum output value of the auxiliary braking force, in accordance with current vehicle speed and road surface μ information, each acquired by the vehicle information acquisition unit, the external environment information, such as travel path curvature, acquired by the external recognition information acquisition unit, and the state of operation by the driver acquired by the driver-input information acquisition unit.

9. The braking control device according to claim 5, wherein the braking force calculation unit calculates physical speed limit based on the external environment information, such as travel path curvature, acquired by the external recognition information acquisition unit, together with road surface μ information acquired by the vehicle information acquisition unit, and only when having determined, based on comparison between current vehicle speed acquired by the vehicle information acquisition unit and the physical speed limit, that a sufficient deceleration of the vehicle has not been effectively achieved, the braking force calculation unit continues with the braking control even when the determination has been made based on the driver-input braking force information that the driver has completed the input of the braking force.
